(19) United States
(12) Patent Application Publication
(10) Pub. No.: US 2023/0332385 A1
(43) Pub. Date: Oct. 19, 2023

(54) VERSATILE WATER DELIVERY SYSTEM

(71) Applicant: Elkay Manufacturing Company, Downers Grove, IL (US)

(72) Inventors: Erin S. Potsch, Hoffman Estates, IL (US); Gregory J. Samuels, Glen Ellyn, IL (US); Rhyan N. White, Chicago, IL (US)

(21) Appl. No.: 17/721,986

(22) Filed: Apr. 15, 2022

(51) Int. Cl. B67D 1/08; E03B 9/20; B67D 1/00

(52) U.S. Cl. CPC E03B 9/20; B67D 1/0014; B67D 1/0888; B67D 1/0894; B67D 2210/0001

(57) ABSTRACT

A versatile water delivery system is disclosed. The versatile water delivery system includes one or more features - such as a quick-connect bubbler, a multipurpose connection mount, and/or an easy-to-use pushbutton - to enable the water delivery system to adaptably operate in a number of different environments for various types of users.

### CROSS-REFERENCE TO RELATED APPLICATION

This application claims the benefit of U.S. Provisional Pat. Application No. 63/176,101, filed on Apr. 16, 2021, which is incorporated by reference in its entirety.

### TECHNICAL FIELD

The present disclosure generally relates to water delivery and, more specifically, to a versatile water delivery system.

### BACKGROUND

Water dispensing devices may be used in a variety of environments, including schools, gyms, offices, outdoor public facilities, for example. Each of these environments may have unique challenges related to installation, operation, cleaning, and maintenance or repair.

Existing water dispensing devices typically come in a form factor that is not easily customizable for the particular environment in which they are used. Therefore, there is a need for a versatile water delivery system that is capable of being installed and operating in a number of different environments.

### SUMMARY

Example embodiments are shown for a versatile water delivery system. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

An example water dispensing station comprises a frame including a mounting grate, outer paneling coupled to the frame, a basin defining a drain and a connection mount, a quick-install bubbler configured to couple the basin, and a pushbutton for controlling operation of the quick-install bubbler, the pushbutton being at least partially supported by the connection mount.

Some examples further comprise a filtration status dashboard that is configured to couple to the connection mount of the basin and display a filtration status for the bubbler.

Some examples further comprise a bottle filler configured to couple to the connection mount of the basin. The bottle filler comprises a spout configured to dispense water into an upright bottle. In some such examples, the basin defines recessed grooves that extend from the drain directly below the spout and define a resting surface for the bottle being filled.

In some examples, the outer paneling includes an under-basin panel and a wraparound panel that are detachable from the frame to provide access to a space below the basin.

Another example water dispensing station comprises a basin that comprises a drain and a bubbler mount. The bubbler mount includes an underside and an outer side. The water dispensing station also comprises a bubbler assembly configured to be quickly attached and detached to the bubbler mount of the basin. The bubbler assembly comprises a bubbler housing configured to be coupled to the underside of the bubbler mount, a bubbler head configured to be coupled to the outer side of the bubbler mount, a first set of fasteners configured to couple the bubbler housing to the underside of the bubbler mount, and a second set of fasteners configured to couple the bubbler head to the outer side of the bubbler mount. The second set of fasteners are integrally formed with the bubbler head.

Some examples further comprise a frame and an under-basin panel coupled to the frame. The under-basin panel is configured to detach from the frame to provide access to the underside of the basin of the bubbler mount.

In some examples, the bubbler mount defines a main opening through which a lower portion of the bubbler head is configured to extend, housing-mount holes through which the first set of fasteners are configured to extend, and bubbler-mount holes through which the second set of fasteners are configured to extend.

In some examples, the bubbler head includes a lower portion that is configured to extend through the bubbler mount and into a portion of the bubbler housing when the bubbler head is coupled to the bubbler mount. In some such examples, the bubbler housing includes an outer surface and defines a retaining groove that extends circumferentially along the outer surface. The bubbler assembly further comprises a retaining ring configured to slide into the retaining groove to clamp the bubbler housing to the lower portion of the bubbler head. Further, in some such examples, the lower portion of the bubbler head defines a circumferential groove that is configured to receive a circumferential ridge of the bubbler housing to snap the bubbler head into place when the lower portion of the bubbler head is inserted into the bubbler housing. Additionally, in some such examples, the retaining groove is located on the bubbler housing such that the retaining ring is configured to be positioned between the inner circumferential ridge and the bubbler mount to deter the bubbler head from being removed from the bubbler housing.

Another example water dispensing station comprises a basin that comprises a drain, a bubbler coupled to the basin, a side panel positioned below the basin, and a pushbutton located along the side panel and configured to control operation of the bubbler. The pushbutton comprises a faceplate configured to be pressed by a user to control operation of the bubbler, a valve, and a body coupled to the faceplate. The body extends from the faceplate and toward the valve. The pushbutton also comprises a linkage that is coupled to and extends between the body and the valve. The faceplate, when pressed by the user, is configured to push the linkage to cause the valve to open and allow the bubbler to emit water.

In some examples, the valve comprises a biasing spring and a plunger. The biasing spring is configured to bias the plunger closed and the faceplate to a rest position when the faceplate is released by the user.

In some examples, the pushbutton is a mechanically-activated linearly-actuated button, without a hinged configuration or electronic activation, to enable the pushbutton to actuate the valve when any portion of the faceplate is pressed by the user with a relatively-low force.

In some examples, the pushbutton further comprises a connecting pin that extends through aligned holes of the body and the linkage to couple the body and the linkage together. The linkage, the body, and the connecting pin are configured to accommodate rotation of the faceplate about a pivot point formed by the connecting pin. Some such examples further comprise a mounting grate that is located below the basin. The valve is mounted to the mounting grate below the basin. Further, some such examples further comprise a boss that extends from the mounting grate and through aligned slots of the body and the linkage. The boss is configured to guide and limit translation of the linkage when the faceplate is pressed by the user.

Another example water dispensing station comprises a basin that comprises a drain located at a lowest point of the basin, a bubbler mount, and a connection mount located toward a back end of the basin. The connection mount includes an elevated surface. The elevated surface defines a set of mounting holes and defines a set of cutouts through which at least one of plumbing or electrical wiring is to extend. The water dispensing station also comprises a bubbler coupled to the bubbler mount of the basin such that the bubbler is oriented to face toward the drain.

Some examples further comprise a filtration status dashboard configured to be mounted to the connection mount of the basin. The filtration status dashboard includes an LED to identify a filtration status. In some such examples, the filtration status dashboard further includes a printed circuit board that is electrically connected to the LED. The printed circuit board is configured to cause the LED to emit a first light color or pattern when the water dispensing station further includes a filter unit for the bubbler and the filter unit is in operation, a second light color or pattern when the water dispensing station does not include the filter unit or the filter unit is not in operation, and a third light color or pattern when the filter unit is expired. In some such examples, the filtration status dashboard further includes a gasket configured to sealingly engage a lip formed by the connection mount when the filtration status dashboard is mounted to the connection mount.

Some examples further comprise a bottle filler configured to be mounted to the connection mount of the basin and fastened to an adjacent wall. In some such examples, the bottle filler comprises a shroud configured to house a filter, and a spout that is vertically aligned with the drain when the bottle filler is mounted to the connection mount of the basin. Further, in some such examples, the basin further includes protruding surfaces that extend radially outward from the drain to define a resting surface for a bottle during a filling process.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1A illustrates an example water dispensing station in accordance with the teachings herein.

FIG. 1B further illustrates the water dispensing station of FIG. 1A.

FIG. 2 illustrates a bubbler installed on the water dispensing station of FIGS. 1A-1B.

FIG. 3 illustrates a bubbler assembly including the bubbler of FIG. 2.

FIG. 4 is a side view of the bubbler of FIG. 2.

FIG. 5 depicts a portion of the bubbler assembly FIG. 3 being installed on the water dispensing station of FIGS. 1A-1B.

FIG. 6 further depicts the bubbler assembly of FIG. 3 being installed on the water dispensing station of FIGS. 1A-1B.

FIG. 7 further depicts the bubbler assembly of FIG. 3 being installed on the water dispensing station of FIGS. 1A-1B.

FIG. 8 depicts the bubbler assembly of FIG. 3 installed on the water dispensing station of FIGS. 1A-1B.

FIG. 9 is a perspective view of a pushbutton of the water dispensing station of FIGS. 1A-1B for operating the bubbler of FIG. 2.

FIG. 10 is a perspective view of the pushbutton of FIG. 9 as installed on the water dispensing station of FIGS. 1A-1B.

FIG. 11 is a top view of the pushbutton of FIG. 9 as installed on the water dispensing station of FIGS. 1A-1B.

FIG. 12 is a side cross-sectional view of the pushbutton of FIG. 9 as installed on the water dispensing station of FIGS. 1A-1B.

FIG. 13A depicts a filtration status dashboard being installed via a connection mount of the water dispensing station of FIGS. 1A-1B.

FIG. 13B illustrates the filtration status dashboard of FIG. 13A installed on the water dispensing station of FIGS. 1A-1B via the connection mount of FIG. 13A.

FIG. 14 illustrates a bottle filler installed on the water dispensing station of FIGS. 1A-1B via the connection mount of FIG. 13A.

FIG. 15 further depicts a portion of the bottle filler of FIG. 14.

FIG. 16 depicts a connection between the bottle filler of FIG. 14 and the connection mount of FIG. 13A.

FIG. 17 further depicts a connection between the bottle filler of FIG. 14 and the connection mount of FIG. 13A.

FIG. 18 illustrates a door of the bottle filler of FIG. 14.

FIG. 19 depicts an upper portion of the door of FIG. 18.

FIG. 20 depicts a lower portion of the door of FIG. 18.

FIG. 21 depicts a cap plate of the bottle filler of FIG. 14.

FIG. 22 depicts a portion of the cap plate of FIG. 21 coupled to the door of FIG. 18.

FIG. 23 depicts a portion of a hinged connection of the door of FIG. 18.

FIG. 24 depicts a door stop assembly for the door of FIG. 20.

FIG. 25 further depicts a portion of the door stop assembly of FIG. 24.

FIG. 26 illustrates a drain of a basin of the water dispensing station of FIGS. 1A-1B.

FIG. 27 depicts a top view of the drain of FIG. 26 and a conduit extending from the drain.

FIG. 28 depicts a side, partial-cutaway view of the drain and conduit of FIG. 27.

FIG. 29 is another perspective view of the water dispensing station of FIGS. 1A-1B.

FIG. 30 illustrates a wraparound panel of the water dispensing station of FIGS. 1A-1B.

FIG. 31 illustrates a frame of the water dispensing station of FIGS. 1A-1B.

FIG. 32 partially depicts the wraparound panel of FIG. 30 being coupled to the frame of FIG. 31.

FIG. 33 depicts a portion of the wraparound panel of FIG. 30 coupled to a portion the frame of FIG. 31.

FIG. 34 depicts another portion of the wraparound panel of FIG. 30 being coupled to another portion of the frame of FIG. 31.

FIG. 35 depicts the portion of the wraparound panel of FIG. 34 coupled to the portion of the frame of FIG. 34.

### DETAILED DESCRIPTION OF EXAMPLE EMBODIMENTS

While the invention may be embodied in various forms, there are shown in the drawings, and will hereinafter be described, some exemplary and nonlimiting embodiments, with the understanding that the present disclosure is to be considered an exemplification of the invention and is not intended to limit the invention to the specific embodiments illustrated.

An example water dispensing station disclosed herein includes one or more features - such as a quick-connect bubbler, a multi-purpose connection mount, and/or an easy-to-use pushbutton - that enable the water delivery system to adaptably operate in a number of different environments.

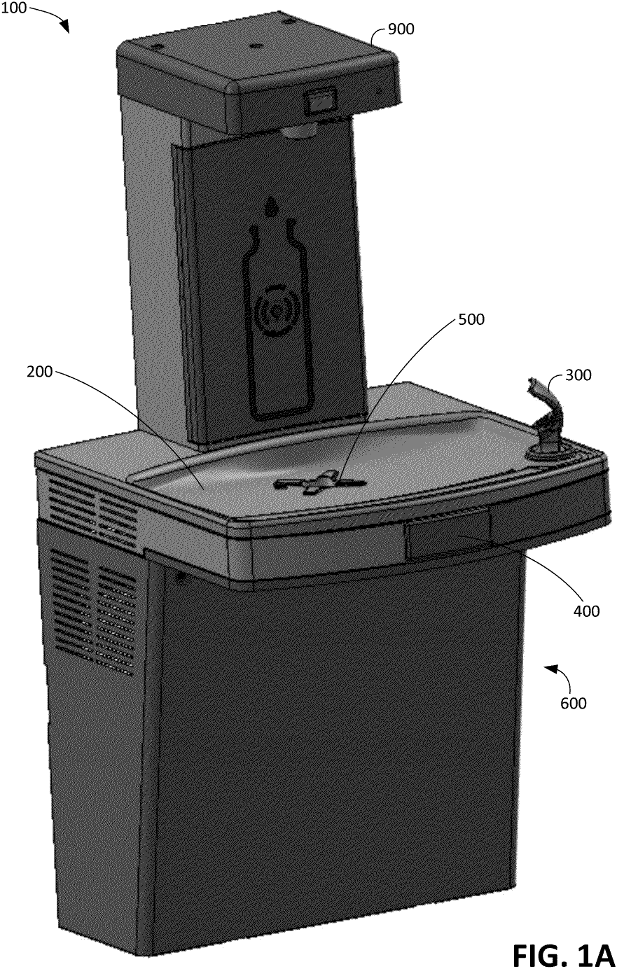

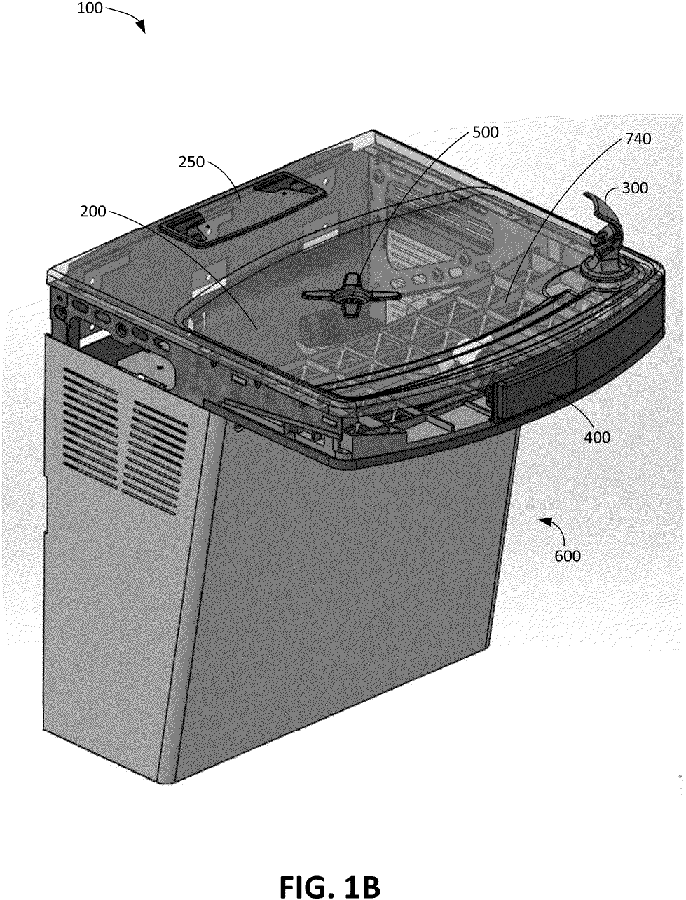

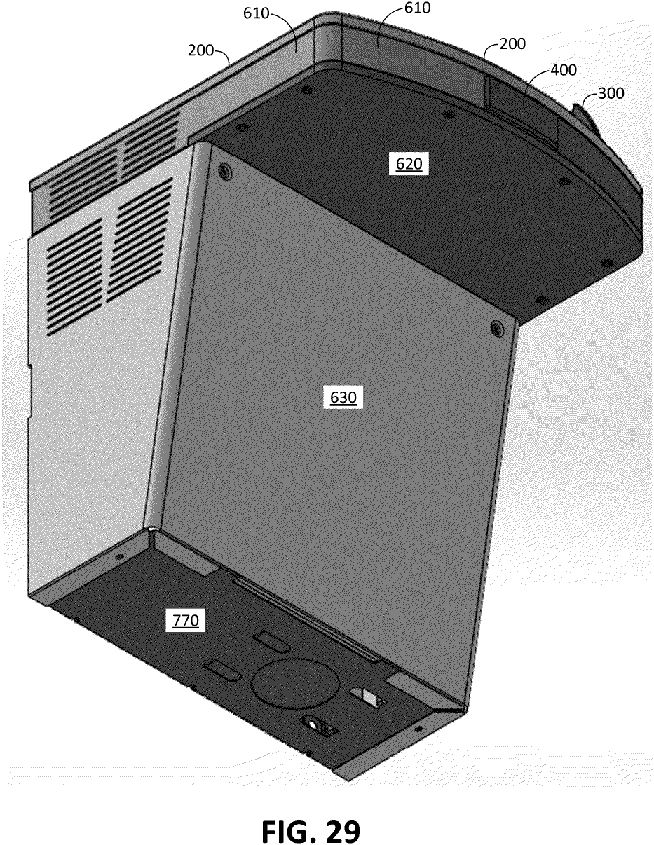

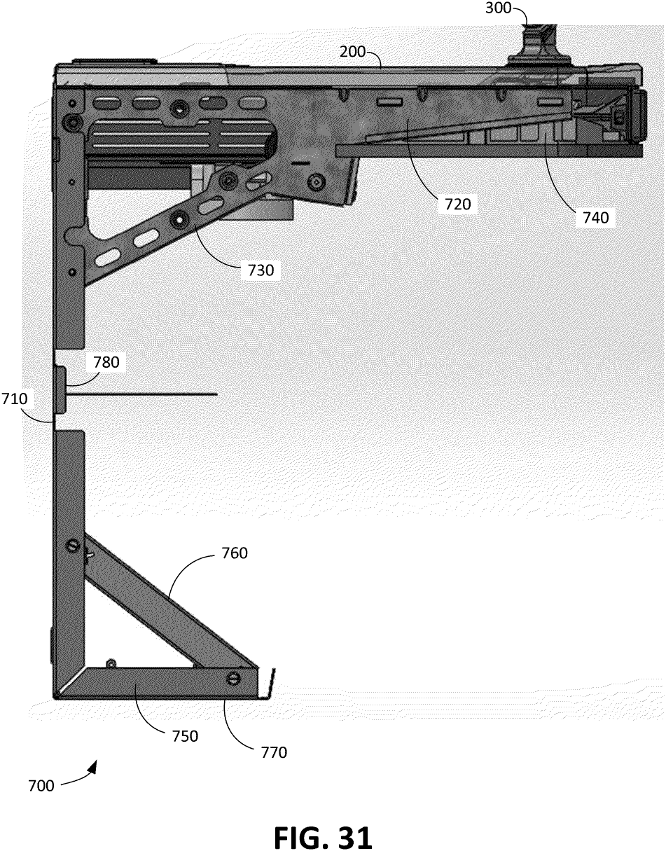

Turning to the figures, FIGS. 1A and 1B illustrate an example water dispensing station 100 in accordance with the teachings herein. The water dispensing station 100 includes a basin 200, a bubbler 300, a pushbutton 400, a drain 500, outer paneling 600, and a frame 700 (shown in FIG. 31). In FIG. 1A, a bottle filler 900 is mounted to the basin 200. In FIG. 1B, a portion of the outer paneling 600 (an upper side panel 610 shown in FIG. 29) is removed and the basin 200 is depicted as being transparent in order to show internal components, such as mounting grate 740, of the water dispensing station 100 located below the basin 200. As shown in FIG. 1B and disclosed in greater detail below, the basin 200 defines a connection mount 220 to which a filtration status dashboard 800 and/or the bottle filler 900 is configured to mount.

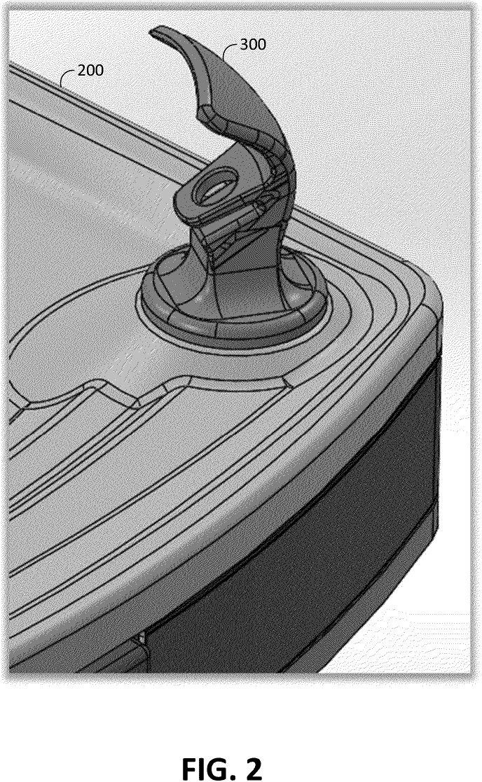

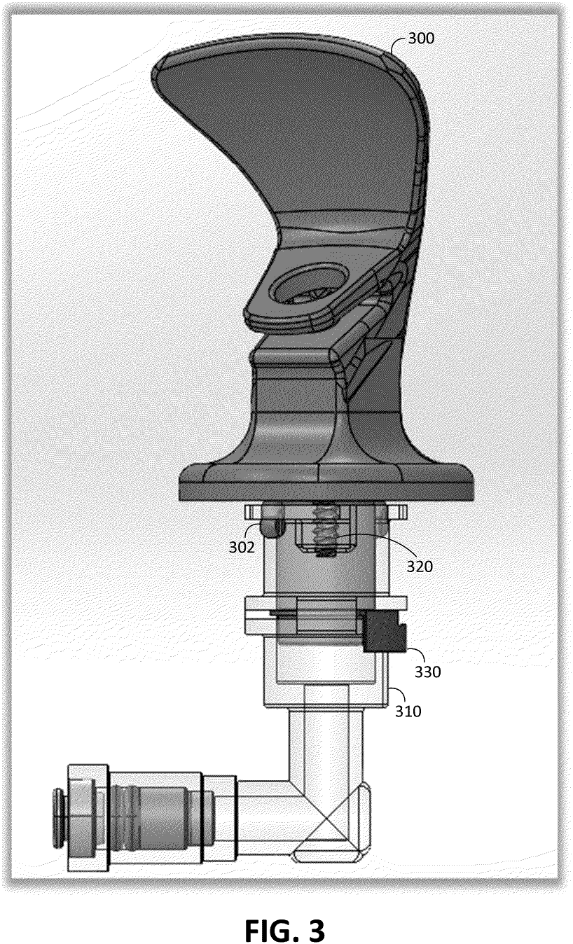

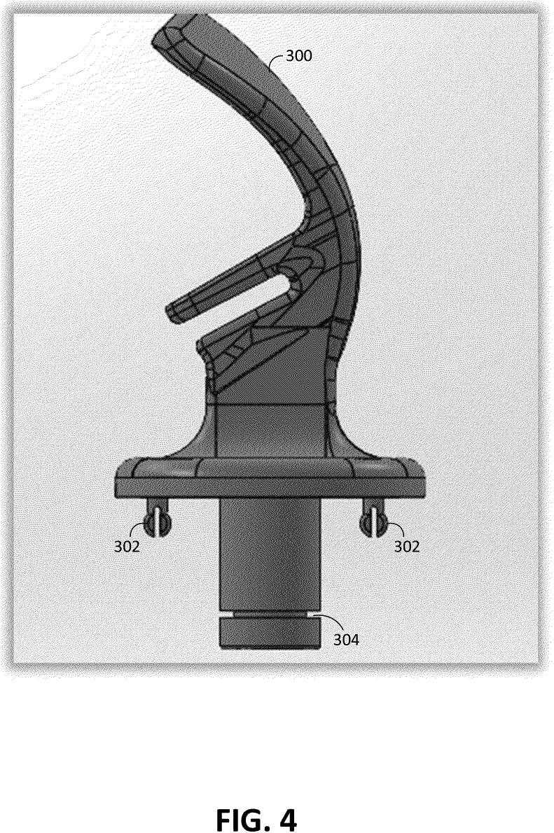

FIGS. 2-8 depict a bubbler assembly of the water dispensing station 100. As illustrated in FIG. 3, the bubbler assembly includes the bubbler 300 (also referred to as a “bubbler head”), a bubbler housing 310, one or more fasteners 320, and a retaining ring 330. As shown in FIG. 4, the bubbler 300 includes one or more fasteners 302 that are integrally formed with the body of the bubbler 300 and extend from a bottom surface of the bubbler 300.

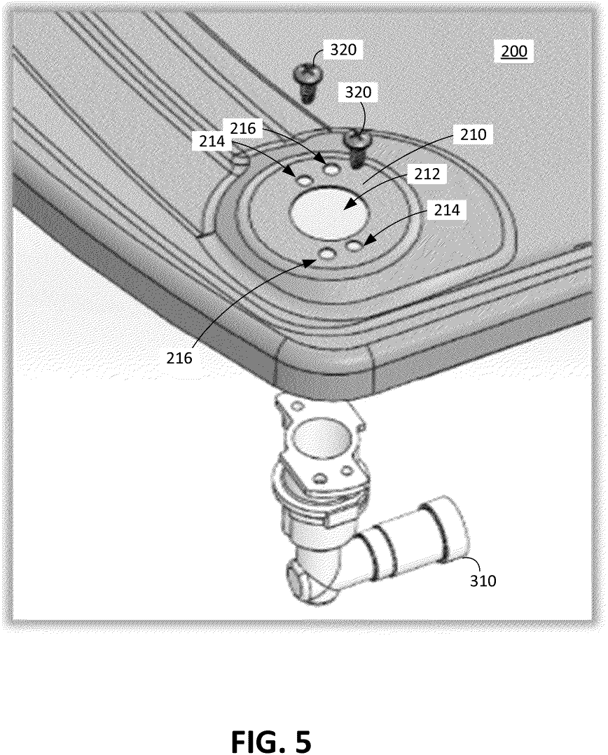

FIGS. 5-8 depict a sequence for installing the bubbler assembly to the basin 200 of the of the water dispensing station 100. The bubbler assembly facilitates a quick-and-easy process to securely attach the bubbler 300 to and/or remove the bubbler 300 from the water dispensing station 100 for an installation and/or replacement of the bubbler 300. The quick-and-easy attachment process enables the bubbler 300 to be shipped unattached from the basin 200, for example, to reduce the likelihood of damage to the bubbler 300 during shipping and/or to reduce the packaging size for the water dispensing station 100. Additionally, the quick-and-easy detachment and attachment process enables an maintenance technician to clean or replace the bubbler 300.

Initially, to install the bubbler assembly to the basin 200, the under-basin panel 620 is detached from the frame 700 of the water dispensing station 100 in order to provide access to an underside of the basin 200. As shown in FIG. 5, once the underside of the basin 200 is accessed, the bubbler housing 310 is coupled to an underside of a bubbler mount 210 defined by the basin 200. The bubbler mount 210 includes a main opening 212 through which a portion of the bubbler 300 is to extend, one or more housing-mount holes 214 through which the fasteners 320 are to extend, and one or more bubbler-mount holes 216 through which the fasteners 302 of the bubbler 300 are to extend. The fasteners 320 (e.g., threaded fasteners) extend through the housing-mount holes 214 and are received (e.g., threadably received) by the bubbler housing 310 to couple the bubbler housing 310 to the underside of the bubbler mount 210 of the basin 200.

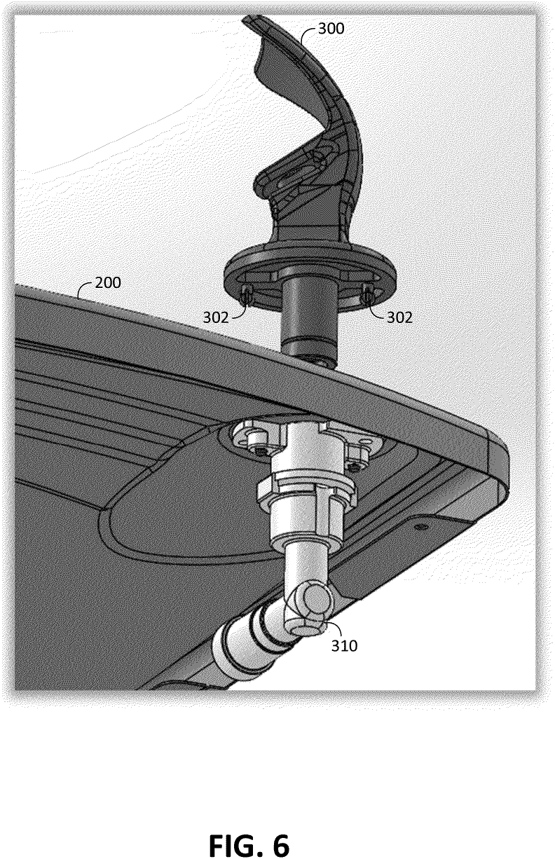

As shown in FIG. 6, once the bubbler housing 310 is fastened to the underside of the bubbler mount 210, the bubbler 300 is coupled to the outer side of the bubbler mount 210. To couple the bubbler 300 to the bubbler mount 210, the fasteners 302 of the bubbler 300 extend through the bubbler-mount holes 216 of the bubbler mount 210. When the bubbler is coupled to the bubbler mount 210, a lower portion of the bubbler 300 extends through the main opening 212 of the bubbler mount 210 and is inserted into a portion of the bubbler housing 310. As shown in FIG. 4, the lower portion of the bubbler 300 defines a circumferential groove 304. When the lower portion of the bubbler 300 is inserted into the bubbler housing 310, the circumferential groove 304 receives a circumferential ridge extending along an inner surface of the bubbler housing 310 to snap the bubbler 300 into place.

In the illustrated example, the housing-mount holes 214, the bubbler-mount holes 216, and the fasteners 302 are arranged to ensure that the bubbler 300 is oriented to face toward the drain 500 of the water dispensing station 100 when installed onto the basin 200. Additionally, in the illustrated example, the fasteners 302 of the bubbler 300 are ball-type snap-fit fasteners to enable the bubbler 300 to be quickly attached to and/or detached from the bubbler mount 210. The snap-fit fasteners compress when being inserted through the bubbler-mount holes 216 and subsequently expand upon passing through the bubbler-mount holes 216 to secure the bubbler 300 to the bubbler mount 210.

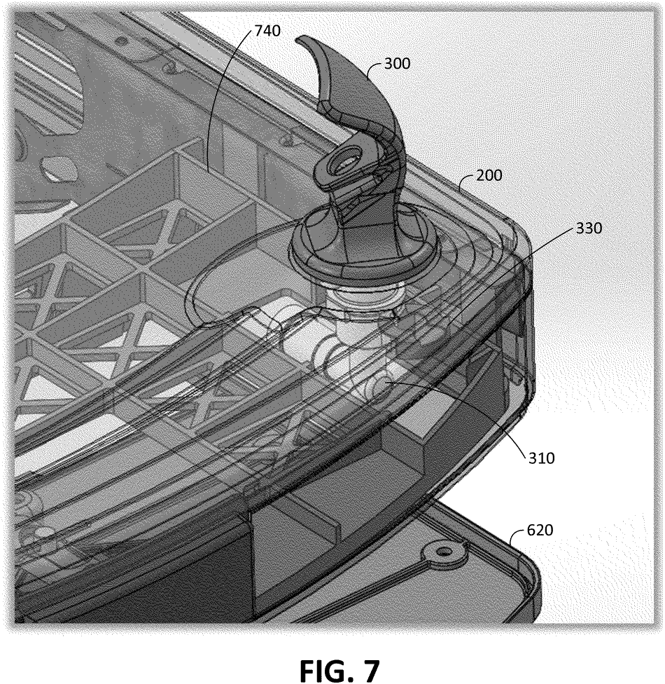

As shown in FIG. 7, the retaining ring 330 is slid into a retaining groove defined circumferentially along an outer surface of the bubbler housing 310. When the retaining ring 330 is slid into the retaining groove and engages the outer surface of the bubbler housing 310, the retaining ring 330 applies a clamping force onto the bubbler housing 310 and, in turn, the lower portion of the bubbler 300 positioned within the bubbler housing 310. The retaining groove of the bubbler housing 310 is defined to be positioned vertically between the inner circumferential ridge of the bubbler housing 310 and the bubbler mount 210 when the bubbler 300 is coupled to the bubbler housing 310 to enable the retaining ring 330 to prevent bubbler 300 from being removed from the bubbler housing 310 when clamped onto the bubbler housing 310. The retaining ring 330 is configured to be removable from the bubbler housing 310 to enable the bubbler 300 to be removed from the bubbler housing 310. Additionally, the retaining ring 330 is located on the underside of the basin 200 to prevent users of the water dispensing station 100 from being able to easily remove the bubbler 300 from the basin 200. In other examples, the bubbler assembly includes security or tamperproof screws that are used, instead of or in addition to the retaining ring 330, in order to securely fasten the bubbler 300 to the bubbler mount 210.

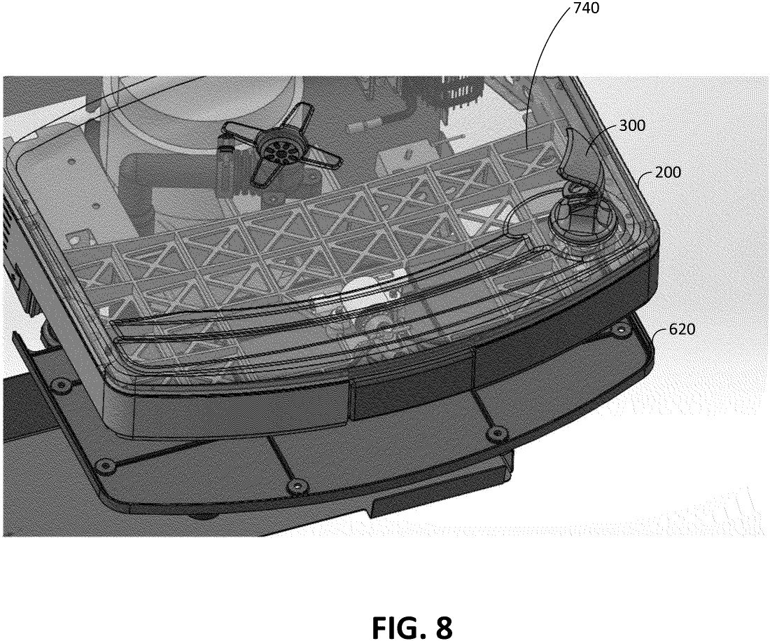

FIG. 8 depicts the bubbler assembly coupled to the basin 200 of the of the water dispensing station 100. Once the bubbler assembly is coupled to the basin 200, the under-basin panel 620 is reconnected to the frame 700.

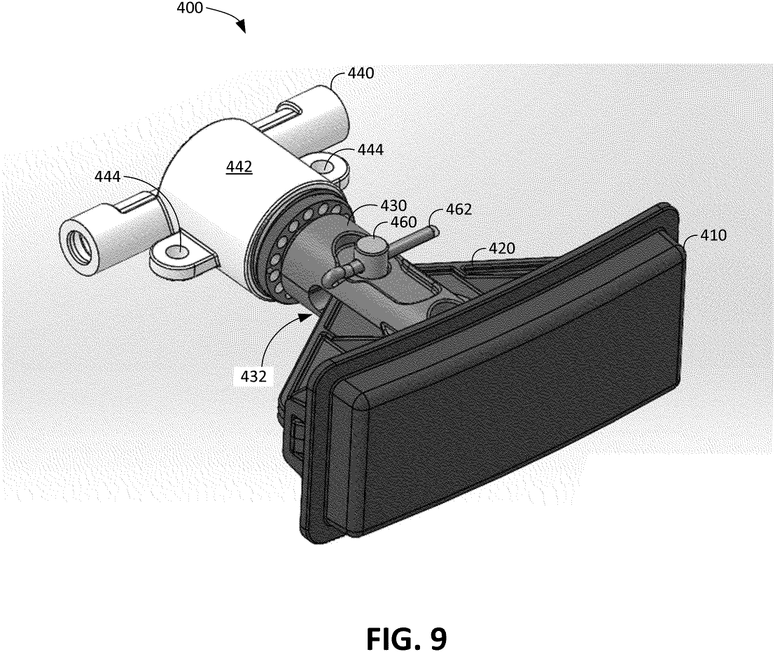

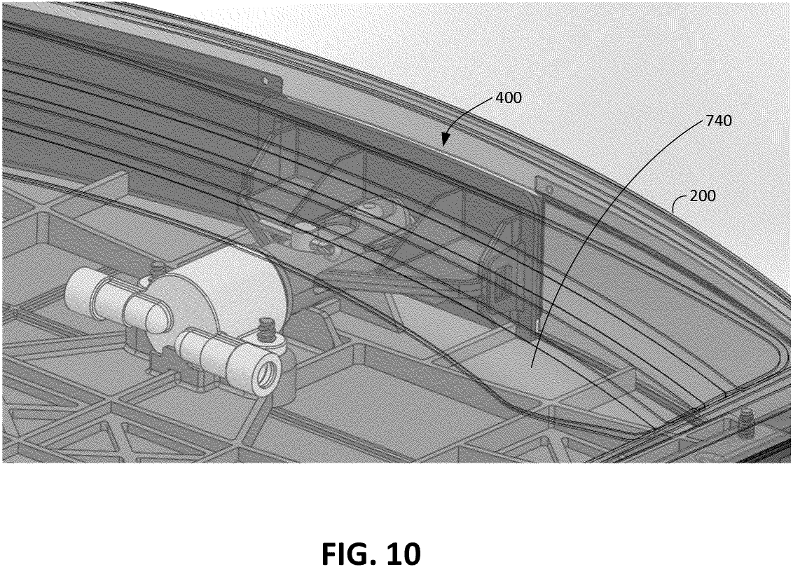

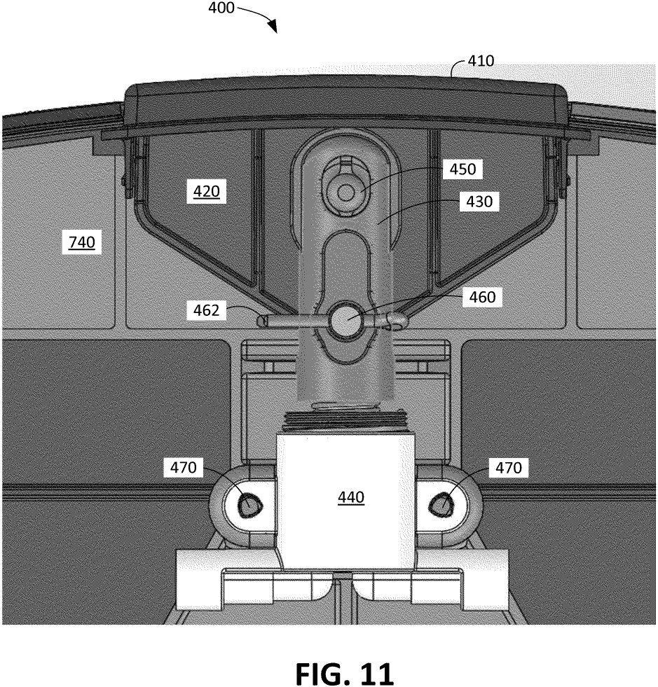

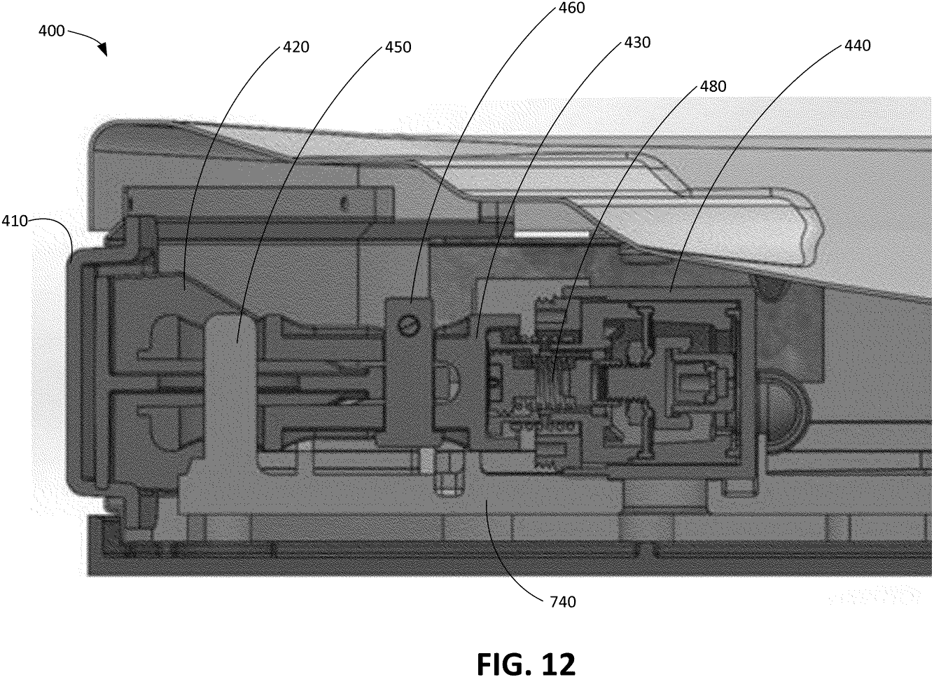

Returning to FIGS. 1A-1B, the pushbutton 400 for controlling operation of the bubbler 300 is located along the upper side panel 610 below the basin 200. Turning to FIGS. 9-12, the pushbutton 400 includes a faceplate 410, a body 420 coupled to and extending from the faceplate 410, and a linkage 430 that is coupled to and extends between the body 420 and a valve 440. The pushbutton 400 is configured to control operation of the bubbler 300. When the faceplate 410 is pressed by a user, the faceplate 410 pushes the linkage 430 to cause the valve 440 to open and allow the bubbler 300 to emit water. When the faceplate 410 is released by the user, a biasing spring 480 (FIG. 12) disposed within the valve 440 pushes the faceplate 410 back to a rest position and causes the valve 440 to close to prevent the bubbler 300 from emitting water.

The pushbutton 400 of the illustrated example is compliant with government and/or other regulatory requirements, such as the Americans with Disabilities Action (ADA), to facilitate operation of the pushbutton 400 by various users. For example, the faceplate 410 has a relatively large surface area to provide a larger area that a user may engage to control the bubbler 300. The pushbutton 400 is also configured to actuate when a relatively low force (e.g., less than 5 pounds) is applied to the faceplate 410 to facilitate users in operating the bubbler 300 via the pushbutton 400. Additionally, the pushbutton 400 is a mechanically-activated linearly-actuated button, without a hinged configuration or electronic activation, such that the pushbutton 400 actuates the valve 440 when a user presses any portion on the faceplate 410 with the relatively low force. In turn, pressing of the pushbutton 400 consistently results in the actuation of the valve 440 to control operation of the bubbler 300.

In the illustrated example, the body 420 and the linkage 430 extend between the faceplate 410 and the valve 440. The valve 440 includes a spring-loaded plunger that is biased by the spring 480 and is operatively connected to the linkage 430. As shown in FIG. 11, the valve 440 is mounted to the mounting grate 740 via fasteners 470 that extend through fastening holes 444 defined by a body 442 of the valve 440. The body 420 is coupled to and extends perpendicularly from an inner surface of the faceplate 410. In some examples, the body 420 is integrally formed with the faceplate 410. As shown in FIG. 9, a portion of the body 420 extends into a u-shaped slot 432 defined by the linkage 430. A connecting pin 460 (e.g., a clevis pin) extends through a set of aligned holes of the body 420 and the linkage 430 to couple the body 420 and the linkage 430 together. As shown in FIG. 12, a head of the connecting pin 460 is positioned on one side of (e.g., below) the body 420 and the linkage 430. Further, a cotter pin 462 extends through an aperture of the connecting pin 460 on an opposing side of (e.g., above) the body 420 and the linkage 430 to enable the connecting pin 460 to secure the body 420 and the linkage 430 together. Additionally, a boss 450 extends from the mounting grate 740 and through a set of aligned slots of the body 420 and the linkage 430. In the illustrated example, the body 420 and the linkage 430 are not directly supported by any portion of the mounting grate 740.

In operation, a force applied to the faceplate 410 transfers to the linkage 430 via the body 420 and the connecting pin 460. The force overcomes an opposing force of the biasing spring 480 and causes the linkage 430 to actuate toward the valve 440. Actuation of the linkage 430 causes the spring-loaded plunger of the valve 440 to actuate in a manner that causes the valve 440 to open. Additionally, the configuration of the linkage 430, the body 420, and the connecting pin 460 accommodates some rotation of the body 420 and, in turn, the faceplate 410 about a pivot point formed by the connecting pin 460. Additionally, the boss 450 guides and limits translation of the linkage 430 when the faceplate 410 is pressed. That is, as the force is transferred from the faceplate 410, the body 420 and the linkage 430 travel horizontally relative to the mounting grate 740 and rotatably about the connecting pin 460 to facilitate actuation of the valve 440 when a user presses any portion on the faceplate 410 with the relatively low force. During this process, the linkage 430 prevents the faceplate 410 from binding and becoming stuck against the upper side panel 610 of the water dispensing station 100. When the faceplate 410 is subsequently released by the user, the biasing spring 480 pushes the faceplate 410 back to a rest position via the spring-loaded plunger, the linkage 430, and the body 420. In turn, actuation of the linkage 430 causes the valve 440 to close.

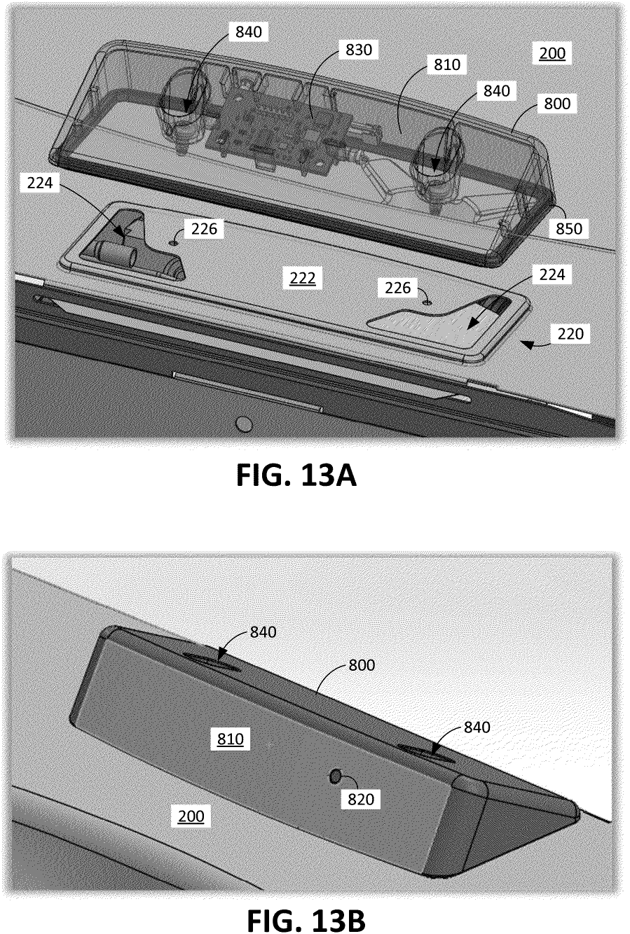

Returning to FIG. 1B, the basin 200 includes the connection mount 220 located toward a back end of the water dispensing station 100. As shown in FIG. 13A, the connection mount 220 includes an elevated surface 222 that defines a set of cutouts 224 and a set of mounting holes 226. In the illustrated example, one of the cutouts 224 and one of the mounting holes 226 is located at each opposing end of the connection mount 220. The elevated surface 222, the cutouts 224, and the mounting holes 226 may be formed, for example, via a stamping process.

The connection mount 220 is configured to enable the filtration status dashboard 800, the bottle filler 900, or a cover plate to be fastened to the basin 200 at any given time. That is, the connection mount 220 enables the water dispensing station 100 to transition between a plurality of different configurations. For example, the water dispensing station 100 is configured to include a filtered bubbler configuration in which the water dispensing station 100 has a filter unit, an unfiltered bubbler configuration, and/or a filtered bottle filler configuration. The cutouts 224 of the connection mount 220 enable plumbing and electrical wiring to extend from below the basin 200 to the filtration status dashboard 800 or the bottle filler 900 for the various configurations.

FIG. 13A depicts the filtration status dashboard 800 being coupled to the connection mount 220, and FIG. 13B depicts the filtration status dashboard 800 coupled to the basin 200 via the connection mount 220. The filtration status dashboard 800 of the illustrated example includes a housing 810, an LED 820 (also known as a light emitting diode), a printed circuit board 830, mounting holes 840, and a gasket 850.

The LED 820 and the printed circuit board 830 are electrically connected. The LED faces toward the bubbler 300 and the pushbutton 400 to allow a user of the water dispensing station 100 to easily view the status of the LED 820. For example, when (1) the water dispensing station 100 includes a filter unit for the bubbler 300 and (2) the filter unit is in operation, the printed circuit board 830 causes the LED 820 to emit a first light color (e.g., green light) and/or a first light pattern to indicate to a user that the water being dispensed by the bubbler 300 is filtered. When (1) the water dispensing station 100 does not include a filter unit for the bubbler 300 or (2) a filter unit for the bubbler 300 is not in operation, the printed circuit board 830 causes the LED 820 to emit a second light color (e.g., red light) and/or a first light pattern to indicate to a user that the water being dispensed by the bubbler 300 is not filtered. Further, in some examples, the printed circuit board 830 causes the LED 820 to emit a third light color (e.g., yellow light) and/or a third light pattern to indicate that the filter unit has expired.

The mounting holes 840 of the filtration status dashboard 800 are configured to align with the mounting holes 226 of the connection mount 220 to enable fasteners (e.g., security or tamperproof screws) to extend therethrough and couple the filtration status dashboard 800 to the connection mount 220 of the basin 200. Further, the gasket 850 is configured to engage a lip formed by the connection mount 220 to facilitate the filtration status dashboard 800 in being securely fastened to the basin 200. Additionally, the gasket 850 sealingly engages the lip formed by the connection mount 220 to prevent water from flowing from the basin 200 and into the interior of the water dispensing station 100.

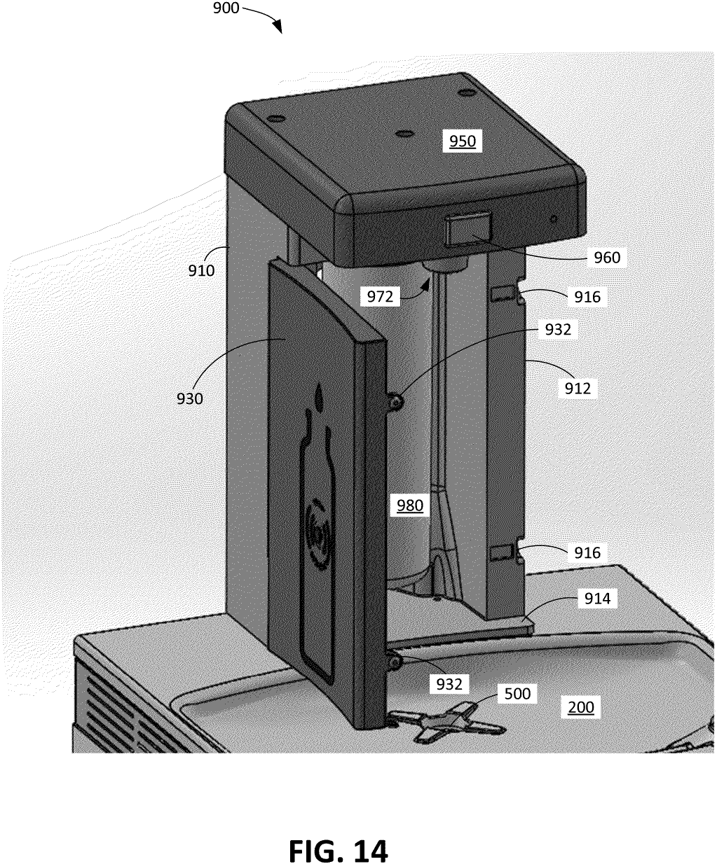

FIG. 14 depicts the bottle filler 900 coupled to the basin 200 via the connection mount 220. To transition the water dispensing station 100 from a filtered configuration or an unfiltered configuration to a filtered bottle filler configuration, the filtration status dashboard 800 is decoupled from the connection mount 220 and the bottle filler 900 is subsequently coupled to the connection mount 220. The connection mount 220 enables the bottle filler 900 to be coupled directly to the body of the water dispensing station 100 prior to subsequently fastening the bottle filler 900 to the adjacent wall. After the bottle filler 900 is secured onto the body of the water dispensing station 100, a maintenance technician is able to fasten the bottle filler 900 to the wall by (1) accurately drilling holes into the wall that align with wall-mount holes of the bottle filler 900 and (2) inserting fasteners through the wall-mount holes of the bottle filler 900 and into the holes drilled into the wall. Thus, the connection mount 220 facilitates the maintenance technician in avoiding misalignment between the bottle filler 900 and the body of the water dispensing station 100 during the installation process of the bottle filler 900, thereby reducing installation time for the bottle filler 900 and/or retrofitting costs for the water dispensing station 100. For example, the connection mount 220 facilitates alignment between a spout 972 of the bottle filler 900 and the drain 500 of the water dispensing station 100. The connection mount 220 also facilitates visual centering of the bottle filler 900 relative to other features of the water dispensing station 100.

As illustrated in FIGS. 14-15, the bottle filler 900 includes a shroud 910, a door 930, a cap 950, a pushbutton 960, a cap plate 970, and a filter 980. The spout 972 is located on an underside of the cap plate 970 and is configured to dispense water into an upright bottle that is positioned between the spout 972 and the basin 200. The pushbutton 960 located along a front surface of the cap 950 enables a user to instruct the spout 972 to dispense water. Additionally or alternatively, the spout 972 is configured to dispense water when a proximity sensor 934 (e.g., an infrared sensor) detect the presence of a bottle below the spout 972. The filter 980 of the bottle filler 900 filters water dispensed by the spout 972. Sides walls 912 of the shroud 910, the door 930, the cap 950, and/or the cap plate 970 securely enclose the filter 980 when the door 930 is closed. The door 930 includes latches 932 that are received by latch slots 916 defined by one of the side walls 912 of the shroud 910. Fasteners (e.g., security or tamperproof screws) are configured to extend through the latch slots 916 and the latches 932 to secure the door 930 in a closed position. As shown in FIG. 14, the door 930 is configured to be opened to enable an maintenance technician to replace and/or service the filter 980. The door 930 is located on a front side of the shroud 910 to facilitate the maintenance technician replacing and/or servicing the filter 980.

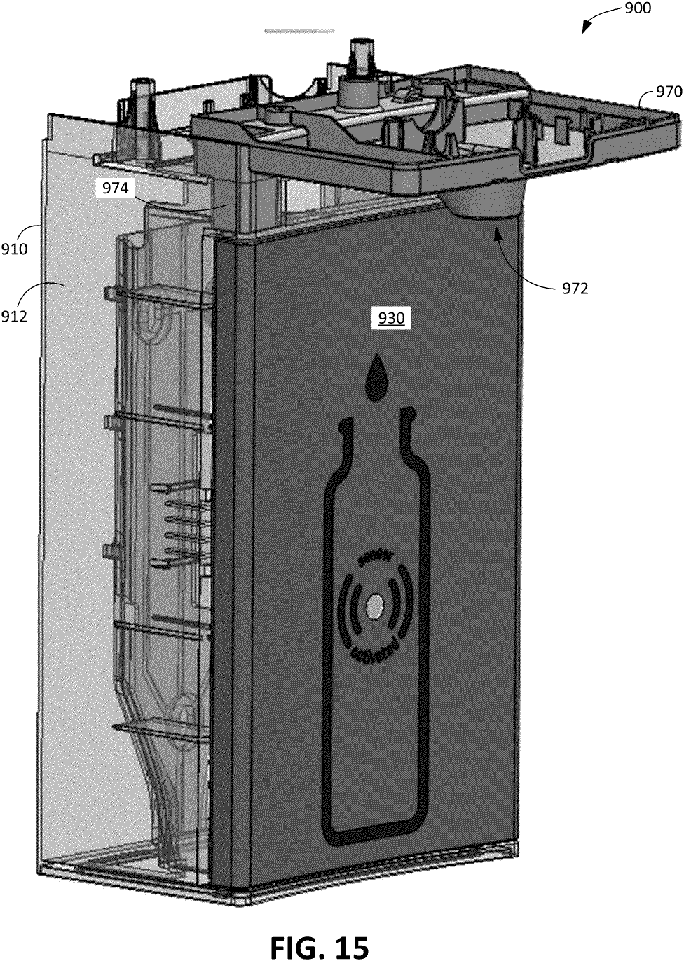

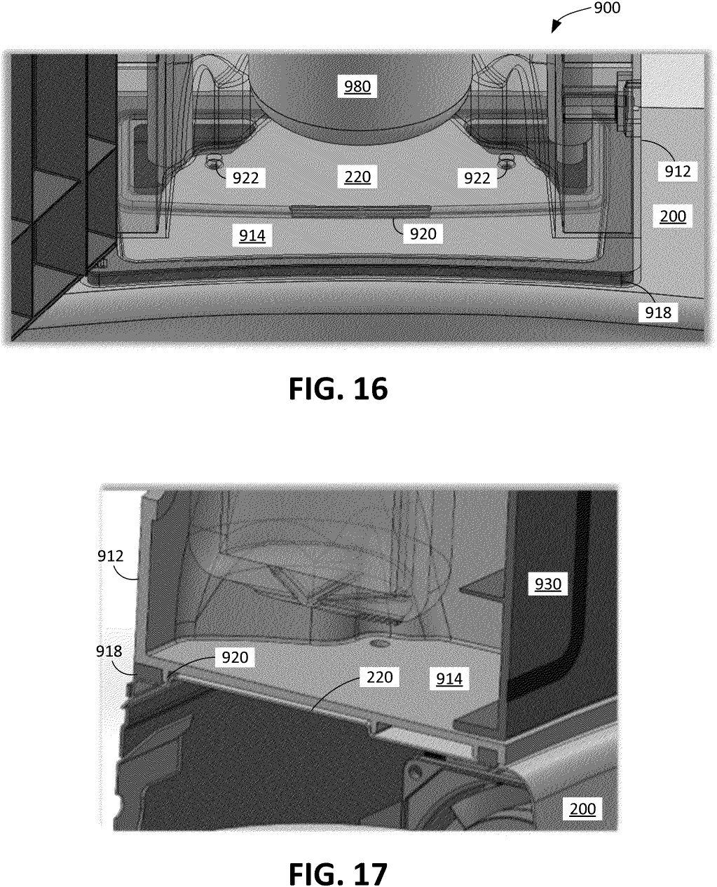

FIGS. 16-17 further depict a base plate 914 of the shroud 910 of the bottle filler 900 that couples to the basin 200 via the connection mount 220. The base plate 914 of the bottle filler 900 defines mounting holes 922 that are configured to align with the mounting holes 226 of the connection mount 220. Fasteners extend through the mounting holes 922 and the mounting holes 226 to fasten the shroud 910 of the bottle filler 900 to the basin 200 of the water dispensing station 100. The base plate 914 of the illustrated example also defines a guide fin 920 that is configured to align with and engage a lip of the elevated surface 222 of the connection mount 220 in order to facilitate alignment between the mounting holes 922 of the bottle filler 900 with the mounting holes 226 of the connection mount 220. Further, a gasket 918 of the bottle filler 900 engages a portion of the basin 200 around the connection mount 220 to facilitate the secure and sealed fastening of the bottle filler 900 to the basin 200.

Further, in some examples, the water dispensing station 100 also includes a cover plate that is configured to couple to the connection mount 220. When neither bottle filler 900 nor the filtration status dashboard 800 are coupled to the connection mount 220, the cover plate is configured to couple to the connection mount 220 to cover the cutouts 224 and the mounting holes 226 of the connection mount 220.

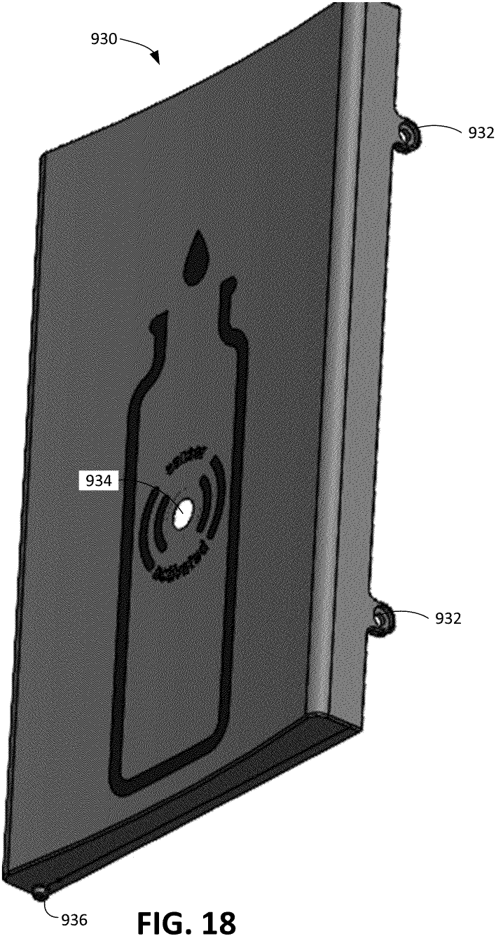

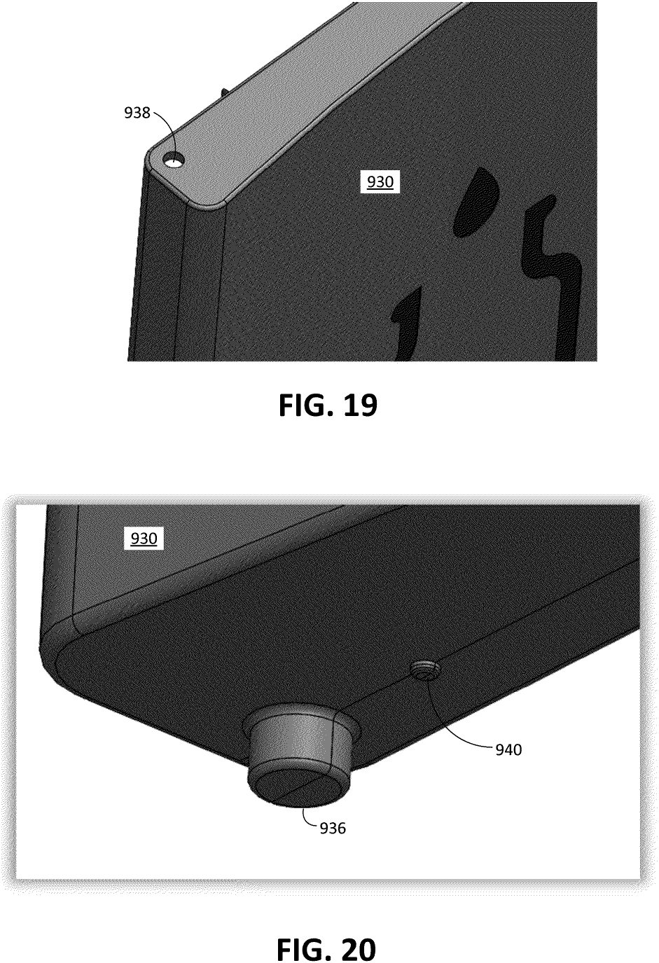

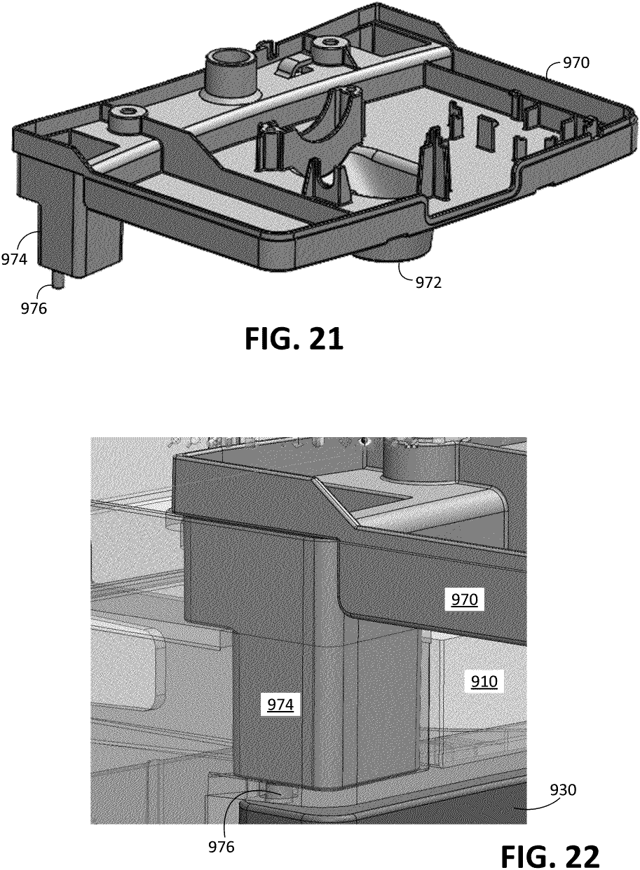

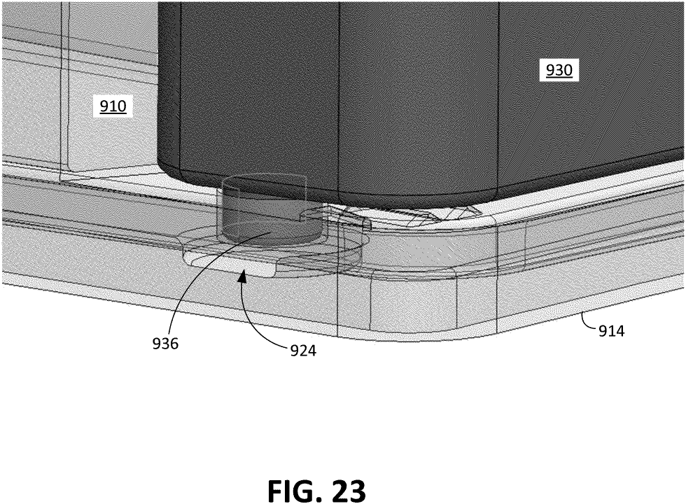

Turning to FIGS. 18-20, the door 930 of the bottle filler 900 includes the latches 932, the proximity sensor 934, a rotation leg 936, a rotation hole 938, and a door-stop protrusion 940. As disclosed above, the latches 932 are received by the latch slots 916 of the shroud 910 to close the door 930, and the proximity sensor 934 is configured to detect the presence of a bottle to enable the spout 972 to fill the bottle in an automated manner without a user having to press the pushbutton 960. In other examples, the bottle filler 900 includes either the proximity sensor 934 or the pushbutton 960, but not both, for activation of the fill sequence. As shown in FIG. 22, the rotation hole 938 receives a pin 976 extending from a leg 974 of the cap plate 970. The pin 976 also extends through a hole of the shroud 910 to facilitate the cap plate 970 in securely coupling to the shroud 910. As shown in FIG. 23, the rotation leg 936 is received by a rotation hole 924 defined by the base plate 914 of the shroud 910. The pin 976 is configured to rotate within the rotation hole 938 and the rotation leg 936 is configured to rotate within the rotation hole 924 to enable the door 930 to rotate open and closed.

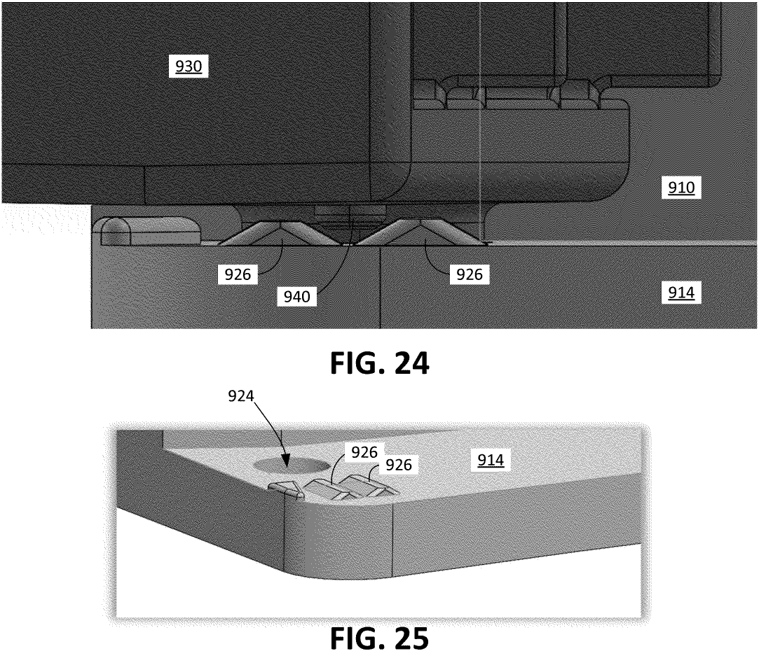

Turning to FIGS. 24-25, the bottle filler 900 includes a mechanism to limit rotation of the door 930. In the illustrated example, the door 930 includes a door-stop protrusion extending from its lower surface that is configured to engage one or more door-stop retention ridges 926 defined along the base plate 914 of the shroud 910 to limit opening of the door 930 to a predefined angle (e.g., 110 degrees). For example, the door-stop retention ridges 926 provides a soft stop to deter the door 930 from swinging against the adjacent side wall 912 of the shroud 910. Additionally or alternatively, the shroud 910 defines a hard-stop emboss to prevent the door 930 from opening beyond a second predefined angle (e.g., 120 degrees) that is greater than the angle associated with the door-stop retention ridges 926.

Returning back to FIGS. 1A-1B, the water dispensing station 100 includes the drain 500 for water dispensed by the bubbler 300 and/or the bottle filler 900. The drain 500 is located at a lowest point of a curved surface of the basin 200 to ensure that all dispensed water that contacts the basin 200 can enter the drain 500.

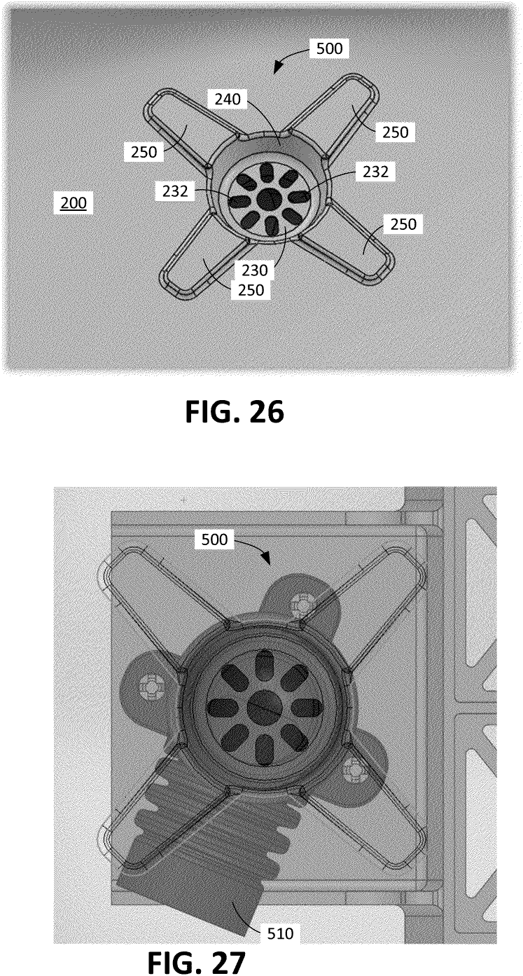

As shown in FIGS. 26-28, the drain 500 is formed from a recessed plate 230 and one or more adjacent side walls 240 of the basin 200 to reduce splashing of water. In the illustrated example, the recessed plate 230 has a circular shape and the side wall 240 extends perpendicular to the outer circumference of the recessed plate 230. In other examples, the recessed plate 230 and the one or more side walls 240 may have any other shape that permits water to be drained in a manner that reduces splashing. The recessed plate 230 and the side wall 240 of the illustrated example defines a recessed into and through which water flows for draining. The recessed plate 230 defines drain holes 232 through which water is drained into a conduit 510.

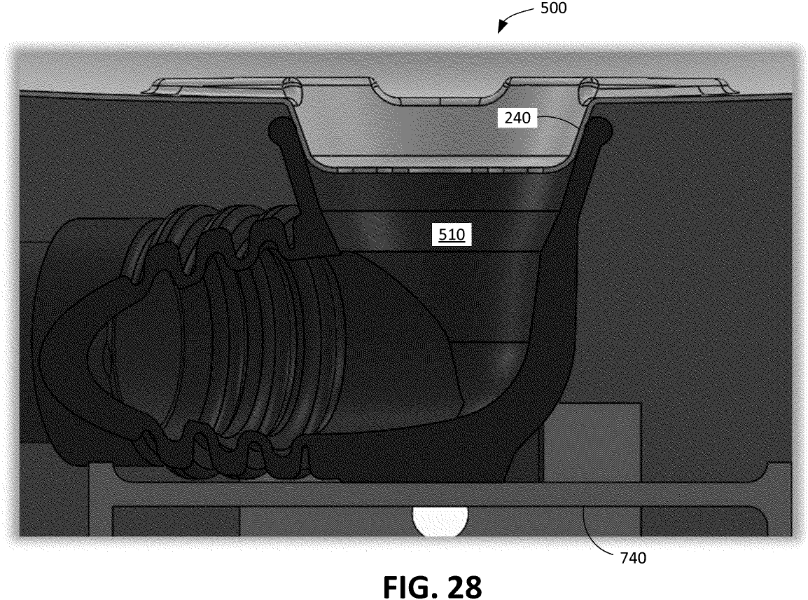

As shown in FIG. 28, an end of the conduit 510 sealingly engages an outer surface of the side wall 240 on the underside of the basin 200 to fluidly connect the drain 500 to the conduit 510. The end of the conduit 510 is configured to form a tight seal with side wall 240 without any additional hardware. For example, the conduit 510 is composed of a rubber material that enables the conduit 510 to form the seal against the side wall 240. An opposing end of the conduit 510 connects to plumbing (e.g., standard-sized PVC) to drain the water. Further, in the illustrated example, a portion of the conduit is rests on the mounting grate 740 for support below the drain 500.

Returning briefly to FIG. 14, the drain 500 is positioned along the basin 200 such that the drain 500 is directly below the spout 972 of the bottle filler 900 when the bottle filler 900 is fastened to the basin 200. That is, the spout 972 vertically aligned with the drain 500 when the bottle filler 900 is mounted to the connection mount 220 of the basin 200. As shown in FIGS. 26-27, the basin 200 defines protruding surfaces 250 that extend radially outward from the drain 500. The protruding surfaces 250 are arranged to define a secure resting surface of the basin for a bottle during a filling process. That is, the protruding surfaces 250 act in concert to form a pedestal on which a bottle may securely rest while water is being dispensed from the spout 972 and into the bottle.

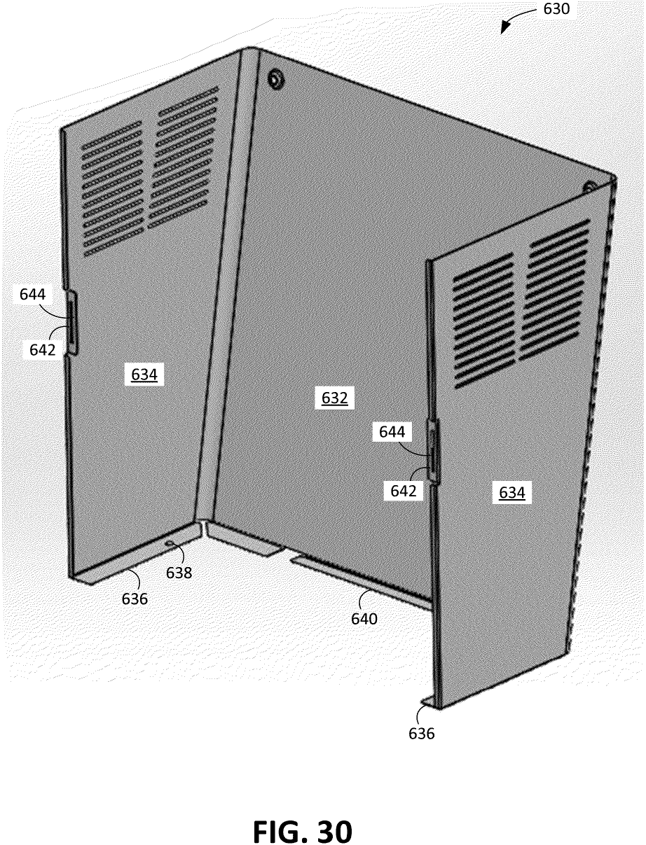

FIGS. 29-35 depict portions of the water dispensing station 100 formed by the outer paneling 600 and the frame 700. As shown in FIG. 29, the outer paneling 600 includes the upper side panel 610, the under-basin panel 620, and a lower panel 630. The lower panel 630 is configured to facilitate a single maintenance technician in quickly and easily coupling the lower panel 630 to and/or decoupling the lower panel 630 from the frame 700 for maintenance of the water dispensing station 100. As shown in FIG. 30, the lower panel 630 is a wraparound panel that includes a front panel 632 and opposing side panels 634 that are integrally formed together. Each of the side panels 634 extends transversely from an opposing side of the front panel 632.

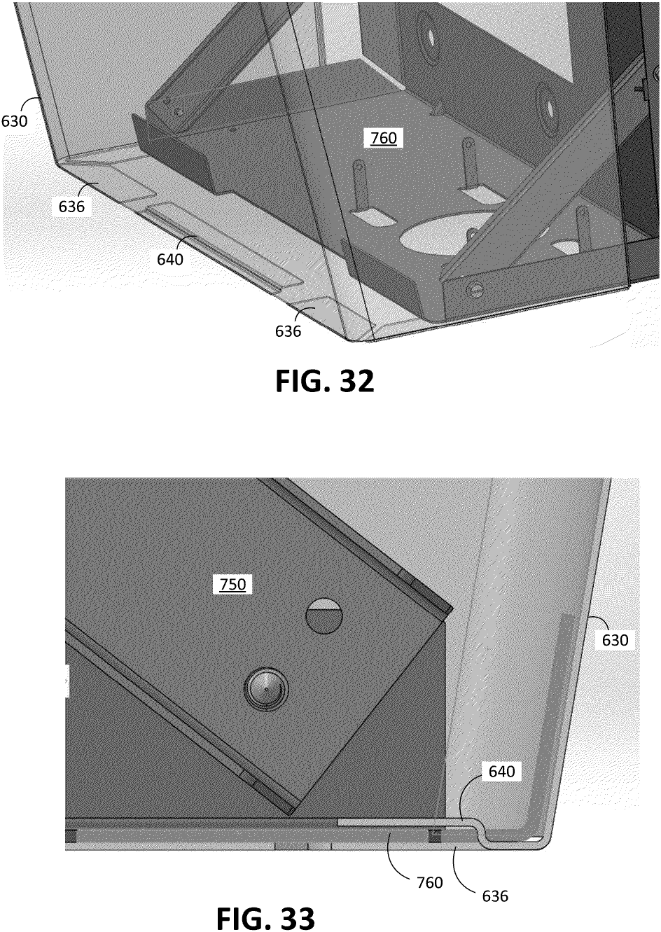

A plurality of flanges 636 extend from a bottom edge of the lower panel 630. The flanges 636 are configured to enable the lower panel 630 to securely couple to a bottom plate 770 of the frame 700. For example, two of the flanges 636 extending from the side panels 634 each defines a mounting hole 638 through which fasteners (e.g., security or tamperproof screws) extend for fastening the lower panel 630 to the bottom plate 770. Additionally, one of the flanges 636 that extends from the front panel 632 is a capture flange 640. As shown in FIGS. 32-33, the capture flange 640 is bent or curved slightly upward such that the capture flange 640 extends over the bottom plate 770. The capture flange 640 is configured to hold the lower panel 630 at least partially in place to prevent the lower panel 630 from falling downward as the lower panel 630 is coupled to the frame 700. The capture flange 640 also facilitates in the alignment of the side panels 634 relative to the frame 700.

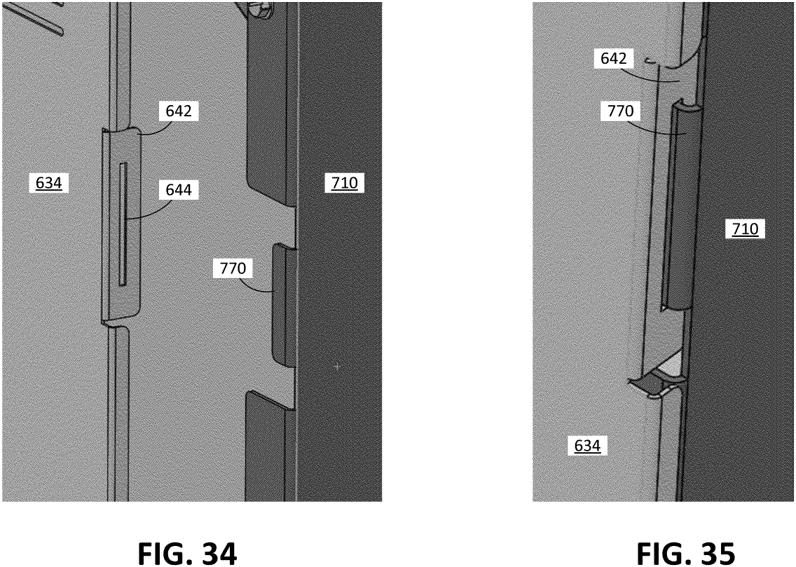

Returning to FIG. 30, a side flange 642 extends transversely from a respective side edge of each of the side panels 634 of the lower panel 630. Each of the side flanges 642 defines a respective slot 644. As shown in FIGS. 34-35, each of the slots 644 receives a respective side flange 780 extending transversely from a back panel 710 of the frame 700 to securely couple the lower panel 630 to the frame 700. Each of the side flanges 642 of the lower panel 630 is configured to hang from a respective one of the side flanges 780 of the back panel 710. In turn, the side flanges 780 provide vertical support to temporarily hold the lower panel 620 in place as a maintenance technician applies fasteners for securing the lower panel 630 to the frame 700. For example, a first set of fasteners fasten the lower panel 630 to the mounting grate 740 of the frame 700, and a second set of fasteners fasten the lower panel 630 to the bottom plate 770 of the frame 700.

Turning to FIG. 31, the frame 700 of the water dispensing station 100 includes the back panel 710, an upper support 720, an upper brace 730, the mounting grate 740, a lower support 750, a lower brace 760, the bottom plate 770, and the side flanges 780. The back panel 710 couples to a wall to couple the water dispensing station to the wall. The upper support 720 and the upper brace 730 support the mounting grate 740 and the basin 200 of the water dispensing station 100. Components of the water dispensing station 100, such as the valve 440 and portions of the faceplate 410, are coupled to the mounting grate 740, instead of the under-basin panel 620, to enable the under-basin panel 620 to be easily and quickly removed for servicing the underside of the basin 200 without removing the basin 200 from the frame 700.

The upper brace 730 forms an A-frame type structure with the upper support 720 and the back panel 710 to enable a distal end of the basin 200 to be supported without adjacent side framing. Similarly, the lower brace 760 forms an A-frame type structure with the lower support 750 and the back panel 710. In some examples, two or more components of the frame 700 are integrally formed together. In the illustrated example, the back panel 710 and the bottom plate 770 are formed from a single sheet of metal that is bent into shape with the lower support 750 being formed of flanges that extend transversely from side edges of the bottom plate 770. Further, the upper support 720 and the upper brace 730 are integrally formed together and couple to flanges extending transversely from the back panel 710.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A water dispensing station, comprising:
a basin comprising a drain and a bubbler mount, wherein the bubbler mount includes an underside and an outer side;
a bubbler assembly configured to be quickly attached and detached to the bubbler mount of the basin, the bubbler assembly comprising:
a bubbler housing configured to be coupled to the underside of the bubbler mount;
a bubbler head configured to be coupled to the outer side of the bubbler mount;
a first set of fasteners configured to couple the bubbler housing to the underside of the bubbler mount; and
a second set of fasteners configured to couple the bubbler head to the outer side of the bubbler mount, the second set of fasteners being integrally formed with the bubbler head.

2. The water dispensing station of claim 1, further comprising a frame and an under-basin panel coupled to the frame, wherein the under-basin panel is configured to detach from the frame to provide access to the underside of the basin of the bubbler mount.

3. The water dispensing station of claim 1, wherein the bubbler mount defines a main opening through which a lower portion of the bubbler head is configured to extend, housing-mount holes through which the first set of fasteners are configured to extend, and bubbler-mount holes through which the second set of fasteners are configured to extend.

4. The water dispensing station of claim 1, wherein the bubbler head includes a lower portion that is configured to extend through the bubbler mount and into a portion of the bubbler housing when the bubbler head is coupled to the bubbler mount.

5. The water dispensing station of claim 4, wherein the bubbler housing includes an outer surface and defines a retaining groove that extends circumferentially along the outer surface, and wherein the bubbler assembly further comprises a retaining ring configured to slide into the retaining groove to clamp the bubbler housing to the lower portion of the bubbler head.

6. The water dispensing station of claim 5, wherein the lower portion of the bubbler head defines a circumferential groove that is configured to receive a circumferential ridge of the bubbler housing to snap the bubbler head into place when the lower portion of the bubbler head is inserted into the bubbler housing.

7. The water dispensing station of claim 6, wherein the retaining groove is located on the bubbler housing such that the retaining ring is configured to be positioned between the inner circumferential ridge and the bubbler mount to deter the bubbler head from being removed from the bubbler housing.

8. A water dispensing station, comprising:
a basin comprising a drain;
a bubbler coupled to the basin;
a side panel positioned below the basin; and
a pushbutton located along the side panel and configured to control operation of the bubbler, the pushbutton comprising:
a faceplate configured to be pressed by a user to control operation of the bubbler;
a valve;
a body coupled to the faceplate, wherein the body extends from the faceplate and toward the valve; and
a linkage that is coupled to and extends between the body and the valve,
wherein the faceplate, when pressed by the user, is configured to push the linkage to cause the valve to open and allow the bubbler to emit water.

9. The water dispensing station of claim 8, wherein the valve comprises a biasing spring and a plunger, wherein the biasing spring is configured to bias the plunger closed and the faceplate to a rest position when the faceplate is released by the user.

10. The water dispensing station of claim 8, wherein the pushbutton is a mechanically-activated linearly-actuated button, without a hinged configuration or electronic activation, to enable the pushbutton to actuate the valve when any portion of the faceplate is pressed by the user with a relatively-low force.

11. The water dispensing station of claim 8, wherein the pushbutton further comprises a connecting pin that extends through aligned holes of the body and the linkage to couple the body and the linkage together, wherein the linkage, the body, and the connecting pin are configured to accommodate rotation of the faceplate about a pivot point formed by the connecting pin.

12. The water dispensing station of claim 11, further comprising a mounting grate that is located below the basin, wherein the valve is mounted to the mounting grate below the basin.

13. The water dispensing station of claim 12, further comprising a boss that extends from the mounting grate and through aligned slots of the body and the linkage, wherein the boss is configured to guide and limit translation of the linkage when the faceplate is pressed by the user.

14. A water dispensing station, comprising:
a basin comprising:
a drain located at a lowest point of the basin;
a bubbler mount; and
a connection mount located toward a back end of the basin, wherein the connection mount includes an elevated surface, wherein the elevated surface defines a set of mounting holes and defines a set of cutouts through which at least one of plumbing or electrical wiring is to extend; and
a bubbler coupled to the bubbler mount of the basin such that the bubbler is oriented to face toward the drain.

15. The water dispensing station of claim 14, further comprising a filtration status dashboard configured to be mounted to the connection mount of the basin, wherein the filtration status dashboard includes an LED to identify a filtration status.

16. The water dispensing station of claim 15, wherein the filtration status dashboard further includes a printed circuit board that is electrically connected to the LED, wherein the printed circuit board is configured to cause the LED to emit:
a first light color or pattern when the water dispensing station further includes a filter unit for the bubbler and the filter unit is in operation;
a second light color or pattern when the water dispensing station does not include the filter unit or the filter unit is not in operation; and
a third light color or pattern when the filter unit is expired.

17. The water dispensing station of claim 15, wherein the filtration status dashboard further includes a gasket configured to sealingly engage a lip formed by the connection mount when the filtration status dashboard is mounted to the connection mount.

18. The water dispensing station of claim 14, further comprising a bottle filler configured to be mounted to the connection mount of the basin and fastened to an adjacent wall.

19. The water dispensing station of claim 18, wherein the bottle filler comprises:
a shroud configured to house a filter; and
a spout that is vertically aligned with the drain when the bottle filler is mounted to the connection mount of the basin.

20. The water dispensing station of claim 19, wherein the basin further includes protruding surfaces that extend radially outward from the drain to define a resting surface for a bottle during a filling process.
